(19) United States
(12) Patent Application Publication
(10) Pub. No.: US 2017/0072425 A1
(43) Pub. Date: Mar. 16, 2017

(54) Paint Stands

(71) Applicant: Wendell C. Lagarde, Houston, TX (US)

(72) Inventor: Wendell C. Lagarde, Houston, TX (US)

(21) Appl. No.: 14/856,297

(22) Filed: Sep. 16, 2015

(51) Int. Cl. B05C 13/00

(52) U.S. Cl. CPC B05C 13/00

(57) ABSTRACT

A painting support for supporting an object to be painted may include a base for positioning and supporting the object to be painted a predetermined distance from a support surface and a mounting finger being connected to the base to support the object to be painted.

### FIELD OF THE INVENTION

The present invention relates to a painting support to be used to maintain an object to be painted at a predetermined distance from a support so that it can be flawlessly painted.

### BACKGROUND

During the course of their work, professional painters typically paint or otherwise finish objects such as doors, of the type commonly found in houses and other buildings, either installed in the frame or leaning against a wall or other structure. Finishing an object in the vertical position, especially when using an airless or other type paint sprayer, can result in runs or sags in the finish due to gravity, and overspraying onto adjacent surfaces. Also, since a typical construction site can range from very cluttered and dirty to well-maintained, but is rarely pristine, the object resting on or near the floor may have dirt or debris from the floor blown onto it by the sprayer as the finish is applied.

Laying the object flat and horizontal across two sawhorses or other fixture eliminates some of the associated problems, but the necessity of allowing one side to dry before the other side can be finished remains a problem.

Available space and/or sawhorses determine how many objects can be finished at one time. Also, one object must be finished and allowed to dry on both sides before it can be moved to allow space for another object is to be finished.

A device is available for use in finishing objects/doors in the vertical position, whereby the door is suspended in a frame and the door can be rotated in order to finish both sides. However, these devices are large and expensive.

Another device is available in which several doors stand vertically on the floor and are joined on the top edge with an angled piece of metal, whereby the joined doors stand in a zig-zagged pattern and can be finished in this position. This device would possibly be difficult to facilitate in view of the height of a typical door and/or the relative bulkiness of several doors joined together.

With both of the aforementioned devices the problems of runs and sags in the finish still exist, as does the problem of dirt and debris from the floor and available space in the work area.

U.S. Pat. No. 6,090,204 discloses support fixtures to aid in painting or otherwise finishing doors. When four of these support fixtures are attached to the end corners of a door they support the door above the adjacent surface and the door can be turned using the attached handles. This allows all desired surfaces of the door to be finished at one time. A second door similarly equipped with these support fixtures can be likewise finished and then stacked on top of the first door with the finished surfaces of both doors maintained apart. These support fixtures are portable and reuseable.

U.S. Pat. No. 5,509,544 discloses a rack apparatus for drying multiple rigid, painted objects. The apparatus is made up of two identical racks. Each rack has a base, to which is attached two vertical bars, perpendicular to the base, which have in between them a horizontal handle for carrying. Attached to the vertical bars are vertical posts, extending in a direction perpendicular to the base. Each post has multiple hooks which support horizontal poles. When disassembled, the poles and posts can be placed in pole storage holders, which are connected to the base. This allows for the apparatus to be easily transported and space efficient. The apparatus functions by placing the two racks on opposite ends of the rigid object. Spikes are driven into the upper and lower ends of a door or other rigid object. The spikes support the door on spaced sawhorses, where the door is painted. After the painting is complete, the door can be lifted by the spikes and carried to the apparatus, where the door is placed in the apparatus to dry by resting the spikes on the horizontal poles. This invention allows the drying of several doors or other rigid objects simultaneously in the same area and allows for the entire object to be painted at one time. The present invention can also be used as a storage apparatus for holding multiple doors or other rigid objects in showrooms and warehouses, instead of stacking and leaning them against walls, which many times results in surface damage to the doors or rigid objects. Multiple rack assemblies can also be incorporated into a workbench saw table.

U.S. Pat. No. 5,164,011 discloses a door painting fixture which will hold a door in generally vertical position with the door being supported for rotational movement about a centrally located vertical axis to enable a door to be completely painted by the use of any of several paint applying techniques without the necessity of the painter moving to opposite sides of a door or lifting the door and manually rotating it 180.degree. The fixture includes opposed, vertically spaced and aligned pins having tapered or pointed facing ends to engage the top and bottom edges of a door at a center point thereof with the pins being supported by a stand having laterally extending arms supporting the pins with the upper arm including a spring arrangement to bias the upper pin towards the lower pin to retain the door in position in the fixture. The lower arm of the stand includes a structure to frictionally retain the door in 180 degree rotated positions which is in the form of a resilient belt adjustably anchored at its ends and providing an upwardly bowed central portion to frictionally engage the bottom edge of the door to retain the door in one of two 180.degree. related positions. The stand is constructed of so that it can be disassembled or assembled to facilitate its transportation to the site of use.

U.S. Pat. No. 5,111,834 discloses a paint roller flushing stand for supporting a generally cylindrical paint roller having an open upper end under a faucet to facilitate flushing accumulated paint from the paint roller. The paint roller stand includes a base and a disk-shaped mounting pedestal for mounting the paint roller on the base such that the paint roller extends generally upwardly from the base with the open upper end of the paint roller facing generally upwardly. In this way, the paint roller is positioned for receiving water from the faucet into the interior of the paint roller. A leveling mechanism associated with the base can be used to selectively adjust the orientation of the paint roller to maintain portions of the paint roller surrounding the open upper end in a generally horizontal plane such that water received into the paint roller, upon filling the interior volume of the paint roller, spills over the upper end of the plant roller and down all sides thereof in generally equal volume rates.

U.S. Pat. No. 4,660,245 discloses a stand for use by a painter when he manually cleans a bristle paint brush by combing it with a wire brush or brush comb.

U.S. Pat. No. 4,193,375 discloses an elongate floor protecting door painting shield that may be removably secured to a wood door under the lower horizontal edge surface thereof to define two elongate areas on each side of the door to receive spilled paint and prevent the latter defacing the floor surface over which the door is disposed. The shield is preferably formed from a resilient sheet material, and the resiliency of this sheet material being used to maintain the shield in place on the door as the latter is pivoted during a painting operation.

### SUMMARY

A painting support for supporting an object to be painted may include a base for positioning and supporting the object to be painted a predetermined distance from a support surface and a mounting finger being connected to the base to support the object to be painted.

The base may include an aperture to connect to the mounting finger.

The base may be a truncated cone.

The mounting finger include a rod to connect with the base.

The mounting finger may include a cone to connect to the base.

The base may include a ring on a bottom surface of the base.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a painting support of the present invention;

FIG. 2 illustrates a side view of the painting support of the present invention;

FIG. 3 illustrates a side view of the painting base of the present invention;

FIG. 4 illustrates a side view of another embodiment of the painting base of the present invention;

FIG. 5 illustrates a side view of the painting finger of the present invention;

FIG. 6 illustrates a top view of the painting base of the present invention;

FIG. 7 illustrates a bottom view of the painting base of the present invention.

FIG. 8 illustrates a top view of the painting finger of the present invention.

### DETAILED DESCRIPTION

A dirty area is the enemy of all painters. Dirt or debris whether large or small may adhere to a painting surface before the painting surface has dried. The dirt seems to gravitate towards freshly painted surfaces in order to mar a near perfect surface of paint. Most of this dirt or debris seems to be concentrated near the floor. Any movement seem sufficient in order to stir up the dirt or debris around the floor. As a consequence, it is desirable to raise the object to be painted to a sufficient height off the floor or support in order to prevent the dust or debris from reaching the object to be painted resulting in a perfect or near perfect painted surface. Furthermore, it is desirable to have a painting support which is relatively compact in design in order that the painting support may be placed in a toolbox or pocket of the user who may be painting. The painting support 100 of the present invention accomplishes these objectives.

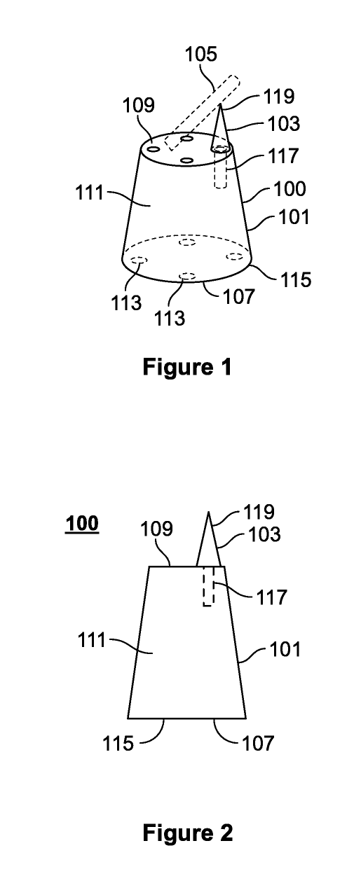

A painting support 100 is illustrated in FIG. 1 which may include a painting base 101 and a mounting finger 103. The object to be painted 105 may be supported by the painting base 101 and the mounting finger 103 or may be supported by one of the painting base 101 or the mounting finger 103.

The painting base 101 may be a truncated cone having a bottom surface 107, an opposing top surface 109 and a peripheral side surface 111 which may connect the bottom surface 107 to the top surface 109. The painting base 101 may be substantially rigid and may be formed from plastic, metal, wood or other appropriate material. The painting base 101 may include axial apertures 113 which may extend through the painting base 101 and may be used to support the mounting finger 103. The bottom surface 107 of the base 101 may include a peripheral ring 115 which may extend around the periphery of the bottom surface 107 in order to reduce the footprint of the painting support 100.

The mounting finger 103 may include a rod 117 to be positioned and cooperate/connect with the base 101 and an end of the rod 107 may be connected to a cone 119 which may support the object to be painted at the termination (point) of the cone 119 in order to provide the minimum invasiveness for the object to be painted.

FIG. 2 illustrates a side view of the painting support 100 which may include a painting base 101 and a mounting finger 103. The object to be painted 105 may be supported by the painting base 101 and the mounting finger 103 or may be supported by only one of the painting base 101 or the mounting finger 103.

The painting base 101 may be a truncated cone having a bottom surface 107, an opposing top surface 109 and a peripheral side surface 111 which may connect the bottom surface 107 to the top surface 109. The painting base 101 may be substantially rigid and may be formed from plastic, metal, wood or other appropriate material. The painting base 101 may include axial apertures 113 which may extend through the painting base 101 and may be used to support the mounting finger 103. The bottom surface 107 of the base 101 may include a peripheral ring 115 which may extend around the periphery of the bottom surface 107 in order to reduce the footprint of the painting support 100.

The mounting finger 103 may include a rod 117 to be positioned and cooperate/connect with the base 101 and an end of the rod 107 may be connected to a cone 119 which may support the object to be painted at the termination (point) of the cone 119 in order to provide the minimum invasiveness for the object to be painted. The mounting finger 103 may be substantially rigid and maybe formed from metal, wood, plastic or other appropriate material.

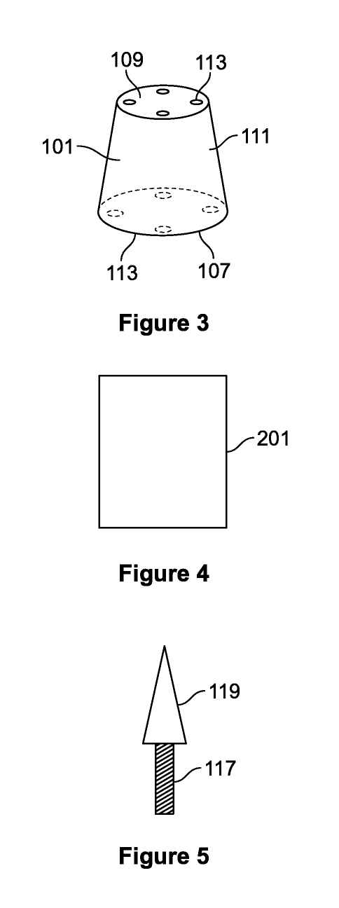

FIG. 3 illustrates a side view of the painting base 101.

The painting base 101 may be a truncated cone having a bottom surface 107, an opposing top surface 109 and a peripheral side surface 111 which may connect the bottom surface 107 to the top surface 109. The painting base 101 may be substantially rigid and may be formed from plastic, metal, wood or other appropriate material. The painting base 101 may include axial apertures 113 which may extend through the painting base 101 and may be used to support the mounting finger 103. The bottom surface 107 of the base 101 may include a peripheral ring 115 which may extend around the periphery of the bottom surface 107 in order to reduce the footprint of the painting support 100.

FIG. 4 illustrates another embodiment of the base 201 which may have a rectangular cross-section.

FIG. 5 illustrates a side view of the mounting finger 103. The mounting finger 103 may include a rod 117 to be positioned and cooperate/connect with the base 101 and an end of the rod 107 may be connected to a cone 119 which may support the object to be painted at the termination (point) of the cone 119 in order to provide the minimum invasiveness for the object to be painted. The mounting finger 103 may be substantially rigid and maybe formed from metal, wood, plastic or other appropriate material.

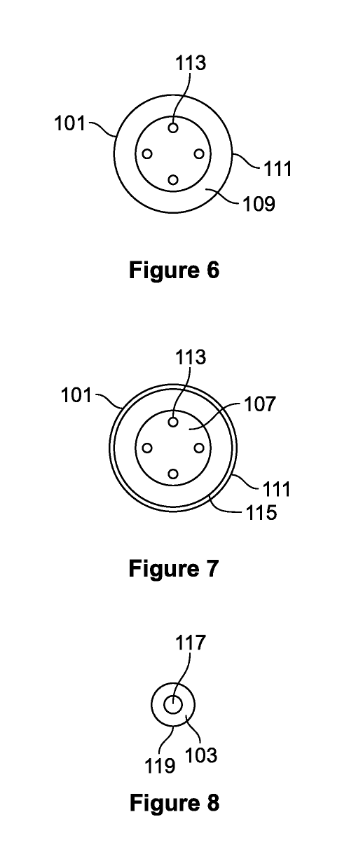

FIG. 6 illustrates a top view of the base 101 and illustrates the top surface 109, the side surface 111 and the aperture 113.

FIG. 7 illustrates a bottom view of the base 101 and illustrates the bottom surface 107, the ring 115, the side surface 111 and the apertures 113.

FIG. 8 illustrates a top view of the mounting finger 103 and illustrates the rod 117 and the: 119.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A painting support for supporting an object to be painted, comprising;
a base for positioning and supporting the object to be painted a predetermined distance from a support surface;
a mounting finger being connected to the base to support the object to be painted.

2) A painting support for supporting an object to be painted as in claim 1, where in the base includes an aperture to connect to the mounting finger.

3) A painting support for supporting an object to be painted as in claim 1, wherein the base is a truncated cone.

4) A painting support for supporting an object to be painted as in claim 1, wherein the mounting finger includes a rod to connect with the base.

5) A painting support for supporting an object to be painted as in claim 1, wherein the mounting finger includes a cone to connect to the base.

6) A painting support for supporting an object to be painted as in claim 1, wherein the base includes a ring on a bottom surface of the base.
